(19) United States
(12) Patent Application Publication
(10) Pub. No.: US 2025/0064049 A1
(43) Pub. Date: Feb. 27, 2025

(54) MECHANICAL DRIVE FOR DECOY

(71) Applicants: Ryan Boyle, Beaverton, OR (US); Wesley Fleming, Palm Harbor, FL (US)

(72) Inventors: Ryan Boyle, Beaverton, OR (US); Wesley Fleming, Palm Harbor, FL (US)

(21) Appl. No.: 18/812,985

(22) Filed: Aug. 22, 2024

Related U.S. Application Data
(60) Provisional application No. 63/578,358, filed on Aug. 23, 2023.

(51) Int. Cl. A01M 31/06; F03G 1/08; F03G 1/10; F16H 35/00; F16H 35/18; F16H 37/12

(52) U.S. Cl. CPC A01M 31/06; F03G 1/08; F03G 1/10; F16H 35/18; F16H 37/122; F16H 2035/006

(57) ABSTRACT

According to an aspect of the present invention, there is provided a mechanical drive for a decoy.

### BACKGROUND

Decoys can be used by hunters to attract ducks. Traditionally, duck decoys have been inanimate structures that are placed on a body of water and allowed to float passively, without movement of any kind. Although stationary decoys generally simulate the appearance of waterfowl, the absence of movement severely limits their effectiveness in attracting waterfowl. As well as ducks, decoys can be used in hunting other animals, and similar considerations apply.

Devices for moveable decoys are known. Many of the apparatus designs known in the prior art are complex in structure, adding to the cost of production and to the difficulty of use. Furthermore, many apparatuses rely on batteries or other forms of electric motors, which are illegal in some locations. Therefore, there is a need for a purely mechanical decoy apparatus which is effective and low-cost.

### SUMMARY OF INVENTION

Accordingly, the present invention provides a mechanical drive for a decoy, comprising a decoy attachment point and a wind up shaft.

According to another aspect of the present invention, a drive arm; and a drive arm shaft and gear.

According to yet another aspect of the present invention, there is provided a spring housing shaft; and a spring housing.

According to yet another aspect of the present invention, there is provided a spring spool shaft; and a spring spool housing.

According to yet another aspect of the present invention, there is provided a spring running between the spring housing and the spring spool housing.

According to yet another aspect of the present invention, there is provided a spring housing output main gear.

According to yet another aspect of the present invention, there is provided a stop/go pin.

According to yet another aspect of the present invention, there is provided a brake.

According to yet another aspect of the present invention, there is provided a handle.

### BRIEF DESCRIPTION OF THE DRAWINGS

FIG. 1 illustrates enclosed decoy drive according to an embodiment of the present invention.

FIG. 2 illustrates the internal components of the decoy drive.

FIG. 3 illustrates a top view of internal components of the decoy drive.

### DETAILED DESCRIPTION

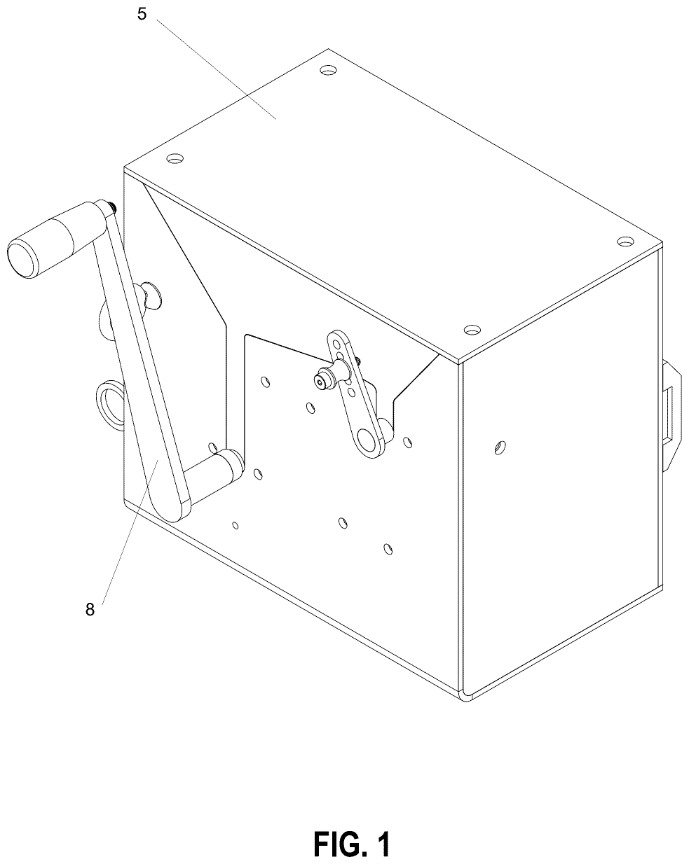

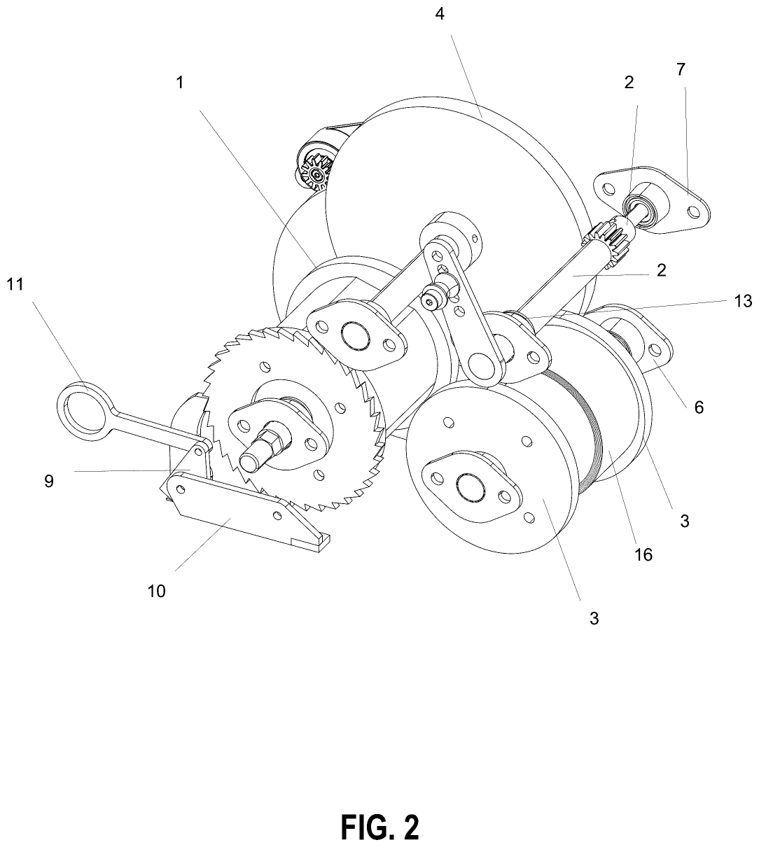

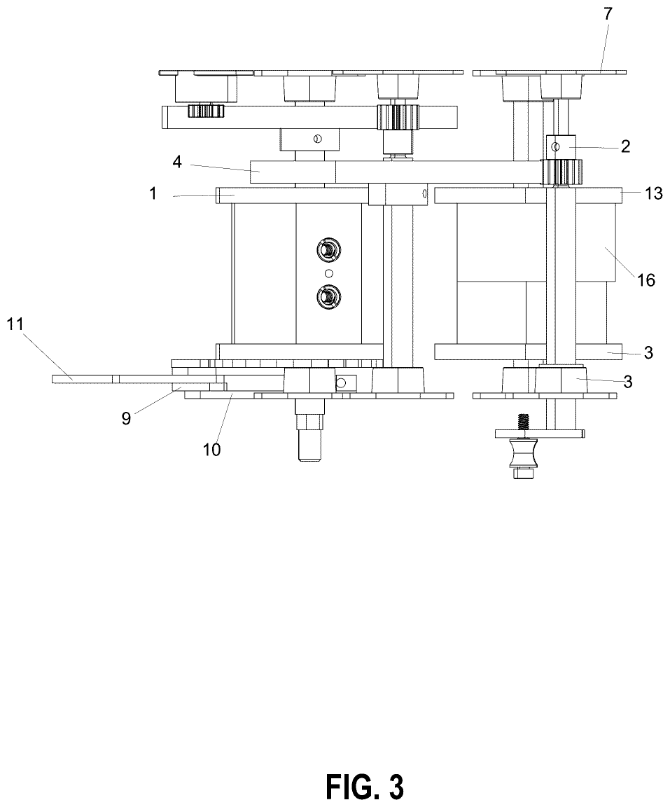

The device according to embodiments of the present invention is illustrated in FIGS. 1-3.

The essential elements of a decoy drive according to the present invention are a decoy attachment point and a wind up shaft. The decoy attachment point is configured to be tied to a decoy via a line, rope, braided thread, cable, or the like. The wind up shaft allows for mechanical energy to be stored within the decoy drive and transferred via the line to provide the source of motion for the decoy.

Some embodiments will further comprise a drive arm and a drive arm shaft and gear. In these embodiments, the drive arm shaft and gear operate to transfer mechanical energy to the line attached to the decoy (or decoys as multiple decoys could be used with embodiments).

Other embodiments will further comprise a spring housing shaft and a spring housing. A spring housing is a circular feature around which a spring can be wound. A spring housing shaft runs through the center of a spring housing. In some embodiments, a handle can be attached to the spring housing shaft and used to transfer mechanical energy which can be stored by the spring.

Yet other embodiments will comprise a spring spool shaft and a spring spool housing. A spring spool housing operates to store a spring on a spool for use with the spring housing and spring housing shaft. A spring spool shaft runs through the center of a spring housing.

Yet other embodiments will further comprise a spring running between the spring housing and the spring spool housing. The spring could be wound around the spring spool housing and then wound around the spring housing to store mechanical energy when mechanical energy is input via the wind up shaft. The spring could be a linear spring in some embodiments.

Yet other embodiments will further comprise a spring housing output main gear. The spring housing output main gear can be connected to a drive arm gear. Gearing with the larger spring housing output main gear makes the smaller drive arm gear rotate more quickly and increases the run time between windings during which the device according to the present invention is able to keep the decoy(s) in motion.

Embodiments can provide a stop/go pin. A stop/go pin keeps the device from recoiling when the device is wound. In other words, a stop/go pin keeps the mechanical energy input via the wind up shaft from being immediately released.

Embodiments can also provide a brake. The brake can be used for modulating the speed at which the device operates. The brake increases the run time as well by conserving the input mechanical energy to use over a longer period of time to keep the decoy(s) in motion.

Some embodiments provide a handle. The handle may be attached to the wind-up shaft of the embodiment. A handle allows for a user to easily input mechanical energy by winding the handle against the resistance provided by the device.

The following elements are illustrated in FIGS. 1-3.
#1 is a drum used to wind and unwind a spring in response to an input from the handle #8.
#2 is the output drive shaft. The output shaft drives accessories.
#3 is a second drum used to store/wind/unwind spring. #3 is where the spring rests when fully unwound.
#4 is a large gear used to connect the drums to output drive shaft #2 to create the optimal run time.
#5 is the casing and housing for the decoy drive.
#6 is a bearing house to hold the output drive shaft #2. There is one bearing housing on each side of the shaft.
#7 is another bearing house to hold the output drive shaft #2.
#8 removable handle used to wind up the stored energy device.
#9, 10, 11 are all part of a start-stop device. When the user pulls on the loop #11, teeth #21 are disengaged and the device starts to unwind and spring goes from drum #1 to drum #3. #9 is a pivot bracket that #10 holds to the decoy drive case.
#13 is another bearing housing to hold the output drive shaft #2.
#16 is the spring which stores mechanical energy to drive the system and winds around drum #3 and drum #1.
#20 is a braking and speed adjustment mechanism.
#21 teeth are provided to engage and disengage the start-stop device.

A wind up/spring housing shaft can be attached to spring housing output main gear. As wind up/spring housing shaft rotates, mechanical energy for driving the decoy via the decoy attachment point builds and is stored in the spring associated with the spring housing shaft. The wind up/spring housing shaft is connected to a spring housing output main gear.

A spring housing output main gear can be provided connected to drive arm gear. Spring housing output main gear in a preferred embodiment is a larger gear than drive arm gear. Accordingly, a mechanical advantage for speed is achieved where a larger gear is driving a smaller gear.

Spring spool shafts arranged on either end of the spring spool shaft. Spring spool housing stores the spring for winding around spring housing when the wind up shaft is activated.

Spring housing and spring spool housing are provided similar in size in a preferred embodiment.

In a preferred embodiment, the device is contained in a box, except drive arm/decoy attachment point and wind up/spring housing shaft are exposed for energy input/output.

In a preferred embodiment, a spring will run in between the two wheels spring spool housing and spring housing to store energy. The length of the spring wrapped around spool housing decreases and the length of the spring wrapped around spring housing increases as mechanical.

In a preferred embodiment, a handle hooks into wind up/spring housing shaft. A handle provides a way to wind up the spring around the spring housing shaft and store mechanical energy which can then be used to drive the decoy(s).

In a preferred embodiment, a stop/go pin and a brake will be around drive arm shaft gear and spring housing output main gear. A variety of configurations are possible.

What is claimed is:

1. A mechanical drive for a decoy, comprising:
a decoy attachment point; and
a wind up shaft;
a drive arm;
a spring;
a spring housing shaft; and
a spring spool housing.

2. The mechanical drive of claim 1, further comprising:
a drive arm gear.

3. The mechanical drive of claim 1, further comprising a spring housing output gear.

4. The mechanical drive of claim 1, further comprising a stop/go pin.

5. The mechanical drive of claim 1, further comprising a brake.

6. The mechanical drive of claim 1, wherein the brake is a torque limiter with a gear and a sealed fluid shaft valved to limit the rate.

7. The mechanical drive of claim 1, further comprising a handle.

8. The mechanical drive of claim 7, wherein:
the handle is attached to the wind-up shaft.

9. The mechanical drive of claim 1, wherein:
the stop/go pin engages and disengages on teeth disposed on a spool housing.
